(19) United States
(12) Patent Application Publication
(10) Pub. No.: US 2015/0313251 A1
(43) Pub. Date: Nov. 5, 2015

(54) READY TO DRINK DAIRY CHOCOLATE BEVERAGES COMPRISING STABILIZER SYSTEM

(71) Applicant: NESTEC S.A., Vevey (CH)

(72) Inventors: Teresita Bautista Pascual, Marysville, OH (US); Jun-Tse Ray Fu, Dublin, OH (US); Virginie Kapchie, Dublin, OH (US); Alexander A. Sher, Dublin, OH (US)

(21) Appl. No.: 14/647,508

(22) PCT Filed: Nov. 29, 2013
(86) PCT No.: PCT/EP13/75179

§ 371 Date: May 27, 2015

Related U.S. Application Data
(60) Provisional application No. 61/732,724, filed on Dec. 3, 2012.

(51) Int. Cl. A23C 9/156; A23L 1/0534; A23L 1/0532; A23C 9/154; A23L 1/0526

(52) U.S. Cl. CPC A23C 9/156; A23C 9/1544; A23L 1/0526; A23L 1/0532; A23L 1/0534; A23V 2002/00

(57) ABSTRACT

Ready to drink dairy chocolate beverages are provided. The beverage can include water, at least one of milk fat or dairy proteins, a cocoa component, and a stabilizing system comprising gellan gum, carrageenan and at least one of carboxymethyl-cellulose, guar gum or tara gum. The beverage can be aseptic and stable in a homogenous state for at least nine months at 4° C., at least six months at 25° C., at least three months at 30° C. and at least one month at 38° C.

### BACKGROUND

The present disclosure generally relates to nutritional products. More specifically, the present disclosure is directed to ready to drink (“RTD”) beverages containing a dairy component and a chocolate component.

The current trend is that consumers are more health conscious and are looking for beverages with less calories but without compromising product taste and texture. In addition, consumers are looking for enhanced mouthfeel, also denoted as richness, texture or creaminess, of the beverages. Thus, many RTD beverages are transitioning from high fat and high sugar versions to versions with less fat and less sugar to limit the calories in the beverage. However, fat and sugar reduction results in a less pleasing mouthfeel of the beverages. Therefore, there is a need for a solution that provides an enhanced mouthfeel of low fat and low sugar RTD dairy chocolate beverages so that the consumer has in increased perception of the texture of the beverage.

At the same time, when improving texture perception of low fat and low sugar RTD dairy chocolate beverages, the long shelf life stability of the beverage cannot be compromised. Such stability is challenging because ingredients added to the beverage to improve mouthfeel typically cause product destabilization, such as undesirable increase of product viscosity and phase separation, e.g. syneresis, layering, creaming and/or sedimentation.

There are no current solutions for shelf stable RTD dairy chocolate beverages with low fat and low sugar content which have a mouthfeel similar to full fat and full sugar beverages. Further, there are no current solutions for aseptic low fat and low sugar RTD dairy chocolate beverages which are shelf stable during the life of the beverage.

For example, U.S. Patent App. Pub. No. 2012/0093980 discloses a protein beverage that contains whey protein concentrate or isolate, milk protein concentrate or isolate, soy protein, caseinate or combinations thereof. The beverage has a stabilizer system which includes carboxymethylcellulose and gellan gum. However, this beverage is a high energy drink and does not solve the issues associated with low fat and low sugar cocoa-containing beverages; the stabilizer system does not improve beverage mouthfeel and does not provide long shelf-life stability of a RTD dairy chocolate beverage.

As another example, PCT App. Pub. No. WO2012/005998 discloses a stabilizer system for use in a RTD whole grain beverage containing carboxymethylcellulose, xanthan gum and gellan gum. In one embodiment, the stabilizing system includes 5 to 20% gellan gum, 1 to 10% xanthan gum and 50 to 90% carboxymethylcellulose. The stabilizer system may be used in milk-based or juice-based whole grain beverages. However, the stabilizer system is formulated to stabilize the starch component which is different from cocoa. Furthermore, the stabilizer does not improve the mouthfeel of the beverages. Moreover, the presence of xanthan gum, especially in combination with carboxymethylcellulose, causes syneresis when cocoa is present.

Therefore, there is a need for aseptic low fat and low sugar RTD dairy chocolate beverages that are shelf stable and have an enhanced mouthfeel that mimics the mouthfeel of full fat and full sugar beverages.

### SUMMARY

The present disclosure generally relates to dairy chocolate beverages. The dairy chocolate beverages can have reduced fat, can have reduced sugar, can be aseptic, can be ready to drink and can have a pleasant mouthfeel. The dairy chocolate beverages can have good physico-chemical stability during ambient storage times e.g., stable for at least nine months at 4° C., at least six months at 25° C., at least three months at 30° C. and at least one month at 38° C. The dairy chocolate beverages can also overcome problems with phase separation such as sedimentation, syneresis, creaming, viscosity change, age gelation, and other phase separation/instability issues during different storage conditions over the full life of the dairy chocolate beverages.

In an embodiment, a beverage is provided. The beverage includes: water; a dairy component; a cocoa component; and a stabilizing system comprising gellan gum, carrageenan and at least one ingredient selected from the group consisting of carboxymethylcellulose, guar gum and tara gum.

In an embodiment, the stabilizing system comprises: gellan gum in an amount from about 0.05% to 0.35% of the beverage; carrageenan in an amount from about 0.0025% to about 0.1% of the beverage; and carboxymethylcellulose in an amount from about 0.05% to 0.2% of the beverage; the viscosity of the beverage being from about 18 cP to about 70 cP at 4° C.

In an embodiment, the stabilizing system comprises: gellan gum in an amount from about 0.11% to 0.35% of the beverage; carrageenan in an amount from about 0.0025% to about 0.1% of the beverage; and guar gum in an amount from about 0.05% to about 0.25% and less than the amount calculated by the equation:

[Guar gum %]=0.575−1.5*[Gellan gum %]

In an embodiment, the stabilizing system comprises: gellan gum in an amount from about 0.05% to about 0.11% of the beverage; carrageenan in an amount from about 0.0025% to about 0.1% of the beverage; and guar gum in an amount from about 0.05% to about 0.25% and more than the amount calculated by the equation:

[Guar gum %]=0.4−3*[Gellan gum %]

In an embodiment, the stabilizing system comprises: gellan gum in an amount from about 0.11% to 0.35% of the beverage; carrageenan in an amount from about 0.0025 to about 0.1% of the beverage; and tara gum in the range from about 0.05% to about 0.25% and less than the amount calculated by the equation:

[Tara gum %]=0.575−1.5*[Gellan gum %]

In an embodiment, the stabilizing system comprises: gellan gum in an amount from about 0.05% to about 0.11% of the beverage; carrageenan in an amount from about 0.0025% to about 0.1% of the beverage; and tara gum in the range from about 0.05% to about 0.25% and more than the amount calculated by the equation:

[Tara gum %]=0.4−3*[Gellan gum %]

In an embodiment, the cocoa component is selected from the group consisting of natural cocoa, alkalized cocoa and combinations thereof. The cocoa component can be present in an amount of from about 0.5% to about 1.5% of the beverage.

In an embodiment, the dairy component comprises less than about 3.0% milk fat. The milk fat can be the only fat in the beverage.

In an embodiment, the beverage includes less than about 6.0% sugar and less than about 0.1% sugarless sweetener.

In an embodiment, the dairy component comprises dairy proteins present in an amount of from about 2.0% to about 4.0% of the beverage.

In an embodiment, the gellan gum is present in the beverage in an amount of about 0.11% of the beverage, and the carrageenan is present in the beverage in an amount of about 0.01% of the beverage.

In another embodiment, a ready to drink aseptic beverage is provided. The aseptic beverage includes: water; a dairy component; a cocoa component; and a stabilizing system comprising gellan gum, carrageenan and at least one ingredient selected from the group consisting of carboxymethylcellulose, guar gum and tara gum, and the stabilizing system maintains the aseptic chocolate beverage in a homogenous state for at least nine months at 4° C., at least six months at 25° C., at least three months at 30° C. and at least one month at 38° C.

In another embodiment, a method of producing a ready to drink dairy chocolate beverage is provided. The method includes the steps of adding a stabilizing system to a dairy component and a cocoa component, the stabilizing system comprising gellan gum, carrageenan and at least one ingredient selected from the group consisting of carboxymethylcellulose, guar gum and tara gum.

An advantage of the present disclosure is to provide an improved ready to drink stable dairy chocolate beverage.

Another advantage of the present disclosure is to provide a ready to drink dairy chocolate beverage that does not have stability issues such as sedimentation, syneresis, creaming, viscosity change, and/or age gelation during storage.

Still another advantage of the present disclosure is to provide a ready to drink dairy chocolate beverage that maintains a pleasant mouthfeel, body, smooth texture, and good flavor without off-notes during the shelf-life.

Yet another advantage of the present disclosure is to provide a ready to drink dairy chocolate beverage that has stability despite reduced fat and reduced sugar.

Another advantage of the present disclosure is to provide a ready to drink dairy chocolate beverage that has reduced fat and reduced sugar but a mouthfeel similar to a full fat and full sugar beverage.

Still another advantage of the present disclosure is to provide a stabilizer system that maintains a cocoa component in suspension in a dairy medium.

Yet another advantage of the present disclosure is to provide a stabilizer system that can stabilize an increased amount of protein in a beverage.

Additional features and advantages are described herein, and will be apparent from, the following Detailed Description.

### BRIEF DESCRIPTION OF THE FIGURES

FIG. 1 shows viscosity profiles of reference compositions and embodiments of beverages according to the present disclosure.

FIG. 2 shows Instability Indexes of reference compositions and embodiments of beverages according to the present disclosure.

FIG. 3 shows an operating window of working ratios and limitations in concentrations of gellan and guar gum combinations and embodiments of the stabilizing system of beverages according to the present disclosure.

### DETAILED DESCRIPTION

All dosage ranges contained within this application are intended to include all numbers, whole or fractions, contained within said range. All percentages expressed herein are by weight of the total weight of the beverage composition unless expressed otherwise. As used in this disclosure and the appended claims, the singular forms “a,” “an” and “the” include plural referents unless the context clearly dictates otherwise. As used herein, “about” is understood to refer to numbers in a range of numerals. Moreover, all numerical ranges herein should be understood to include all integer, whole or fractions, within the range.

The present disclosure relates to shelf-stable RTD beverages containing cocoa and/or a cocoa-based product and containing one or more dairy ingredients (hereinafter “the beverage” or “the beverages”). The beverages can have reduced fat and/or reduced sugar. The beverages can be aseptic and can be stabilized by the use of a complex stabilizing system containing specific combinations of 1) gellan gum, 2) carrageenan and 3) at least one of guar gum, tara gum or carboxymethylcellulose. In a preferred embodiment, the beverages can be shelf-stable for at least nine months at 4° C., at least six months at 25° C., at least three months at 30° C. and at least one month at 38° C.

A unique combination of components were surprisingly found for a stabilizing system that can provide reduced fat and/or reduced sugar aseptic RTD dairy chocolate beverages with good physico-chemical stability during storage while also providing good mouthfeel and a pleasant, indulgent taste. The stabilizing system improves the stability of reduced fat and/or reduced sugar aseptic shelf-stable RTD dairy chocolate beverages by helping to avoid phase separation, creaming, syneresis and the like during the storage of the beverage at ambient temperatures as well as other temperatures.

In a general embodiment, the beverage comprises water, a cocoa component, a dairy component, and a stabilizing system. The water can be treated/filtered water, such as water treated by reverse osmosis, with a total hardness of less than about 10 ppm (e.g., as CaCO₃). The cocoa component can include one or more natural cocoas, alkalized cocoas, and/or other cocoa or chocolate based products. In an embodiment, the cocoa component is present in the beverage in an amount from about 0.5% to about 1.5% of the beverage.

The dairy component can include one or more dairy ingredients or dairy substitute ingredients. For example, the dairy ingredients can be milk, milk fat, milk powder, skim milk, milk proteins and combinations thereof. Examples of suitable dairy proteins are casein, caseinate, casein hydrolysate, whey, whey hydrolysate, whey concentrate, whey isolate, milk protein concentrate, milk protein isolate, and combinations thereof. Furthermore, the dairy protein may be, for example, sweet whey, acid whey, α-lactalbumin, β-lactoglobulin, bovine serum albumin, acid casein, caseinates, α-casein, β-casein and/or γ-casein. Suitable dairy substitute ingredients include soy proteins, rice proteins and combinations thereof, for example. In an embodiment, milk fat is present in the beverage in an amount from about 0% to about 3.0% of the beverage, and dairy proteins are present in the beverage in an amount from about 2.0% to about 4.0% of the beverage. In an embodiment, the milk fat is the only fat source in the beverage. For example, the beverage can have no added oil.

The stabilizing system has gellan gum and carrageenan (e.g., kappa, iota and/or lambda carrageenan). The gellan gum is high acyl gellan gum, low acyl gellan gum or a combination thereof, although preferably the gellan gum comprises high acyl gellan gum that optionally has low acyl gellan gum included. The carrageenan preferably comprises iota carrageenan with other carrageenans optionally included. In a preferred embodiment, the gellan gum is present in the beverage in an amount from about 0.05% to about 0.35% of the beverage and most preferably about 0.11% of the beverage. In a preferred embodiment, the carrageenan is present in the beverage in an amount from about 0.0025% to about 0.1% of the beverage and most preferably about 0.01% of the beverage.

In addition to the gellan gum and the carrageenan, the stabilizing system comprises at least one of carboxymethylcellulose, guar gum or tara gum. If the stabilizing system comprises carboxymethylcellulose, the carboxymethylcellulose is preferably present in the beverage in an amount from about 0.05% to about 0.2% of the beverage. If the stabilizing system comprises guar gum or tara gum, the guar gum or the tara gum is preferably present in the beverage in an amount from about 0.05% to about 0.25% of the beverage and most preferably from about 0.09% to about 0.2% of the beverage.

In an embodiment, the stabilizing system comprises gellan gum, carrageenan and carboxymethylcellulose without any other gum. In another embodiment, the stabilizing system comprises gellan gum, carrageenan and guar gum without any other gum. In yet another embodiment, the stabilizing system comprises gellan gum, carrageenan and tara gum without any other gum.

In an embodiment, the stabilizing system comprises gellan gum in an amount from about 0.11% to 0.35% of the beverage; carrageenan in an amount from about 0.0025% to about 0.1% of the beverage; and guar gum in an amount from about 0.05% to about 0.25% and less than the amount calculated by Equation 1:

[Guar gum %]=0.575−1.5*[Gellan gum %]

In another embodiment, the stabilizing system comprises gellan gum in an amount from about 0.05% to about 0.11% of the beverage; carrageenan in an amount from about 0.0025% to about 0.1% of the beverage; and guar gum in an amount from about 0.05% to about 0.25% and more than the amount calculated by Equation 2:

[Guar gum %]=0.4−3*[Gellan gum %]

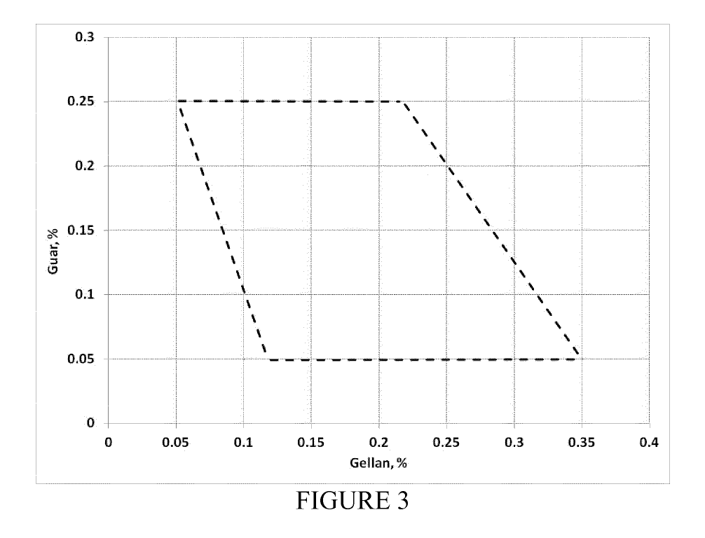

The unique combination of components was found working only within the limits described above for a stabilizing system as illustrated in FIG. 3 that provide reduced fat and/or reduced sugar aseptic RTD dairy chocolate beverages with good physico-chemical stability during storage while also providing good mouthfeel and a pleasant, indulgent taste.

In an embodiment, the stabilizing system comprises gellan gum in an amount from about 0.11% to 0.35% of the beverage; carrageenan in an amount from about 0.0025 to about 0.1% of the beverage; and tara gum in the range from about 0.05% to about 0.25% and less than the amount calculated by Equation 3:

[Tara gum %]=0.575−1.5*[Gellan gum %]

In another embodiment, the stabilizing system comprises gellan gum in an amount from about 0.05% to about 0.11% of the beverage; carrageenan in an amount from about 0.0025% to about 0.1% of the beverage; and tara gum in an amount from about 0.05% to about 0.25% and more than the amount calculated by Equation 4:

[Tara gum %]=0.4−3*[Gellan gum %]

The beverage can be made aseptic to avoid or minimize spoiling. Aseptic treatment of the beverage may be performed by pre-heating the beverage, for example to about 75 to 85° C., and then injecting steam into the beverage to raise the temperature to about 140 to 160° C., for example at about 150° C. The beverage may then be cooled, for example by flash cooling, to a temperature of about 75 to 85° C., homogenized again, further cooled to about room temperature and filled into containers, such as cans. Suitable apparatuses for aseptic treatment of the beverage are commercially available. The stabilizing system can maintain the aseptic RTD dairy chocolate beverage in a homogenous state for at least nine months at 4° C., at least six months at 25° C., at least three months at 30° C. and at least one month at 38° C.

The combination of gellan gum, carrageenan and one of carboxymethylcellulose, guar gum or tara gum in the disclosed amounts was found to assist in maintaining good suspension and emulsion stability of the beverage, avoiding syneresis and other phase separation issues during the storage, and improving mouthfeel. For example, the stabilizing system can maintain the cocoa component in suspension in an aqueous/dairy medium and stabilize proteins while also preventing or minimizing other phase separation issues.

The beverages can also include one or more additional ingredients such as flavorants, artificial sweeteners, natural sweeteners, colorants or a combination thereof. Sweeteners can be sugar-based, such as sucrose, invert syrup, fructose syrup, glucose syrup with various DE, maltodextrins with various DE and combinations thereof, for example. Sugarless sweeteners can include, but are not limited to, sugar alcohols such maltitol, xylitol, sorbitol, erythritol, mannitol, isomalt and lactitol, hydrogenated starch hydrolysates, saccharin, cyclamate, acetosulfame, an L-aspartyl-based sweetener, or mixtures thereof.

Usage level of the flavorants, sweeteners and colorants will vary greatly and will depend on such factors as potency of the sweetener, desired sweetness of the beverage, the level and type of flavor used, and cost considerations. Any suitable combinations of sugar and/or sugarless sweeteners may be used in the chocolate beverages. In an embodiment, sugar is present in an amount less than about 6% of the beverage and preferably present in the beverage in an amount from about 0% to about 6% of the beverage, and sugarless sweeteners are present in the beverage in an amount less than about 0.1% of the beverage and preferably in an amount from about 0.01% to about 0.1% of the beverage.

Non-limiting examples of suitable flavorants include chocolate enhancers, cream/dairy enhancers, vanilla flavors or a combination thereof. In an embodiment, the one or more flavorants are present in the beverage in an amount from about 0.1% to about 0.3% of the beverage.

The required pH value of the final composition can be obtained and/or adjusted by addition of one or more acidulants including but not limited to lactic acid, malic acid, citric acid, tartaric acid, phosphoric acid, glocono delta lactone and combinations thereof. In an embodiment, the one or more acidulants are present in the beverage at a total amount from about 0.01% to about 0.1% of the beverage.

In an embodiment, the beverage further includes one or more vitamins and/or minerals. The vitamins can be present in the beverage in an amount from about 0.01% to about 0.5% of the beverage. The vitamins include, but are not limited to, vitamin C and group B vitamins, and other non-limiting examples of suitable vitamins include ascorbic acid, ascorbyl palmitate, vitamins B1, B2, B6, B12, and Niacin (B3), or combination of thereof. The vitamins may also include Vitamins A, D, E and K and acid vitamins such as pantothenic acid, folic acid and biotin.

The minerals can be present in the beverage in an amount from about 0.0025% to about 1% of the beverage. Non-limiting examples of the minerals include calcium, magnesium, iron or a combination thereof. The source of calcium can include calcium carbonate, calcium phosphate, calcium citrate, other insoluble calcium compounds or a combination thereof. The source of magnesium can include magnesium phosphate, magnesium carbonate, magnesium hydroxide or combination of thereof. The source of iron can include iron ammonium phosphate, ferric pyrophosphate, ferric phosphate, ferrous phosphate, other insoluble iron compounds, aminoacids, iron chelating compounds such as EDTA, or combinations thereof. The minerals may also include zinc, iodine, copper, phosphorus, manganese, potassium, chromium, molybdenum, selenium, nickel, tin, silicon, vanadium and boron.

In another embodiment, the beverage further includes one or more prebiotics. Non-limiting examples of prebiotics include fructooligosaccharides, inulin, lactulose, galactooligosaccharides, soyoligosaccharides, xylooligosaccharides, isomaltooligosaccharides, gentiooligosaccharides, lactosucrose, glucooligosaccharides, pecticoligosaccharides, resistant starches, sugar alcohols or a combination thereof.

The beverages can be made using any suitable process. For example, a process of making the chocolate beverages includes dissolving the raw materials in fluid milk/water and hydration (e.g., wetting) of a chocolate component such as cocoa powder for about 45 minutes to about 90 minutes at about 90° C. to about 95° C. to form the beverage. The beverage can then be subjected to ultra high temperature (“UHT”) heat treatment at about 140° C. to about 151° C. for about 2 seconds to about 12 seconds and aseptic homogenization from about 30 bars to about 300 bars. The UHT heat treatment can be followed by aseptic filling of the beverage into a suitable container.

### EXAMPLES

By way of example and not limitation, the following examples are illustrative of various embodiments of the present disclosure.

### Example 1

Table 1 shows two non-limiting examples of ranges of ingredients in RTD dairy chocolate beverages containing a gellan gum/carboxymethylcellulose/carrageenan stabilizing system and a gellan gum/guar gum/carrageenan stabilizing system in accordance with the present disclosure. The ingredients are listed with amounts expressed in weight percentage of the beverage.

TABLE 1
Example RTD dairy chocolate beverages

| Ingredients | Beverage 1 | Beverage 2 |
|---|---|---|
| Milk fat | 0-3.0 | 0-3.0 |
| Dairy proteins | 2.0-4.0 | 2.0-4.0 |
| Cocoa | 0.5-1.5 | 0.5-1.5 |
| Sugar | 0-6.0 | 0-6.0 |
| Gellan gum | 0.05-0.35 | 0.05-0.35 |
| Guar gum | 0.0 | 0.05-0.25 |
| Carboxymethylcellulose | 0.05-0.2 | 0.0 |
| Carrageenan | 0.0025-0.1 | 0.0025-0.1 |
| Citric Acid | 0.01-0.1 | 0.01-0.1 |
| Flavorants | 0.1-0.3 | 0.1-0.3 |
| Sugarless sweeteners | 0.01-0.1 | 0.01-0.1 |
| Water | remainder | remainder |

### Example 2

Formulations of a full fat and full sugar factory reference (“Full Fat Full Sugar” in the figures), and reduced fat and reduced sugar compositions (S1-S7) with different stabilizing systems are presented in Table 2. The ingredients are listed with amounts expressed in weight percentage of the composition.

For each composition, the process steps for sample preparation were as follows. All ingredients, namely a sugar and gum blend, skim milk, cream, cocoa blend, and water (with part of water saved for the cocoa cooking) were weighed. The water and the sugar and gum blend were mixed for 15 minutes. Cream and skim milk were added, and mixing continued for 15 minutes. The wet cocoa blend was added to the above solution, and homogenization was then performed at 200/50 bars. Samples of the beverages were cooled to about 20-25° C. and then aseptically filled and stored for 1 month at 38° C., 3 months at 30° C. and 6 months at 4° C. and 25° C. Samples with defects were discarded after the defects were observed.

TABLE 2
Examples of some tested compositions

| | Full Fat | | | | | | |
|---|---|---|---|---|---|---|---|
| Ingredient | Full Sugar | S1 | S2 | S3 | S4 | S5 | S6 |
| Fluid | 25 | 40 | 40 | 40 | 40 | 40 | 40 |
| Skimmed | | | | | | | |
| Milk | | | | | | | |
| Milk Cream | 7.5 | 4.5 | 4.5 | 4.5 | 4.5 | 4.5 | 4.5 |
| Sucrose | 11 | 5 | 5 | 5 | 5 | 5 | 5 |
| Cocoa | 1.3 | 1 | 1 | 1 | 1 | 1 | 1 |
| Gellan | 0 | 0.1 | 0.1 | 0.2 | 0.3 | 0.25 | 0.35 |
| Guar Gum | 0 | 0.05 | 0.25 | 0.05 | 0.05 | 0.2 | 0.05 |
| Carrageenan | 0 | 0.005 | 0.005 | 0.005 | 0.005 | 0.005 | 0.005 |
| Water | Remainder | Remainder | Remainder | Remainder | Remainder | Remainder | Remainder |

Rheological measurements were conducted with an Anton Paar Physica MCR 501 rheometer, using a double-gap geometry. These tests were performed to investigate the rheological properties of proposed model system samples. All samples were treated with the following procedure for process and texture evaluations. The viscosity was obtained from 4° C. to 40° C. at a shear rate of 75 s−1 and a heating rate of 2° C./min.

Suspension stability was evaluated using Lumisizer Model 611 which operates using the principle of centrifugation of samples at different g force, for a given time. Transmission profiles were generated, and Space and Time resolved extinction coefficients of the samples were recorded. The difference in the separation rates (Instability Index) between the samples allowed for assessment of relative stability of the products. The higher Instability Index value represents the more unstable product.

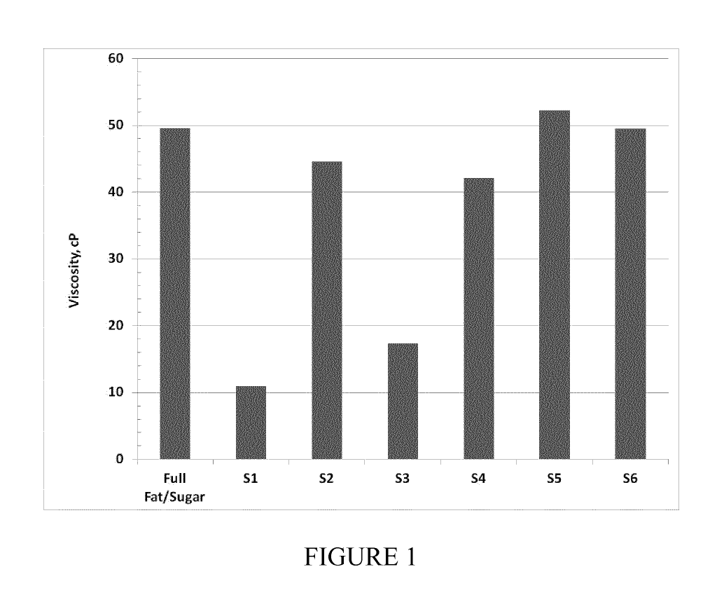

The viscosity data shown in FIG. 1 demonstrates that compositions S3 and S4 were close to the full fat and full sugar reference in viscosity. Further, the viscosity data were in a good correlation with the results of the technical sensory evaluation, i.e. the higher viscosity resulted in the better texture and mouthfeel perception. The viscosity of the products with good texture/mouthfeel was found to be from 18 to 60 cPs at 4° C.

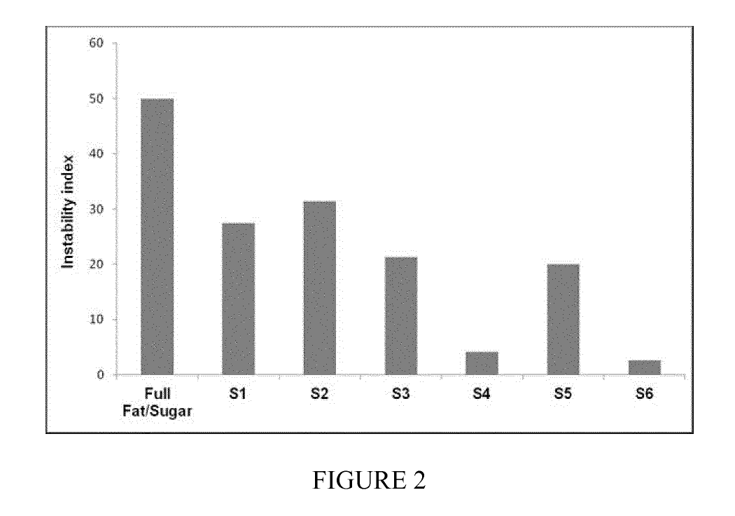

The recipes were analyzed using the LumiSizer under accelerated conditions at 4,000 rpm. The results from the LumiSizer expressed as the Instability Index are shown in FIG. 2. Lumisizer results showed that all S1-S6 compositions presented in Table 2 with the reduced fat and reduced sugar levels performed better than the full fat and full sugar reference. The compositions S4 and S6 containing 0.05% guar and 0.3% or 0.35% of gellan, respectively, and S5 were the most stable.

The full fat and full sugar reference and the reduced fat/reduced sugar compositions S1-S6 were prepared and their physico-chemical and sensory properties were evaluated. Based on technical sensory evaluation results, the compositions that had the most similar texture and mouthfeel attributes to those of the full fat and full sugar reference were compositions S2 and S4-S6.

The above-described sensory results are summarized in Table 3.

TABLE 3
Sensory Evaluation Results Summary

| | Full | | | | | | |
|---|---|---|---|---|---|---|---|
| Test | Fat | S1 | S2 | S3 | S4 | S5 | S6 |
| Sensory attributes | G* | U** | G | U | G | G | G |
| from technical | | | | | | | |
| testing | | | | | | | |

*Good texture/mouthfeel
**Unacceptable texture/mouthfeel

### Example 3

The effect of guar gum concentrations and gellan gum concentrations on the product viscosities were measured as shown in FIGS. 1 and 2. The viscosity data shown in FIG. 1 demonstrates that beverages S2 and S4-S6 are similar to the full fat/full sugar reference in viscosity, indicating that the texture and mouthfeel perception of the beverages should be similar to the full fat and full sugar reference. The results were confirmed by the sensory evaluation. The samples were analyzed using the LumiSizer under accelerated conditions, namely 2 hours at 4,000 rpm. The LumiSizer results demonstrated that the samples better than the full fat/full sugar reference. The results from the LumiSizer expressed as the Instability Index are shown in FIG. 2.

### Example 4

In this and all other examples, concentrations of ingredients are given as w/w % based on the whole product formulation. First, carrageenan (0.005%), gellan gum (0.1%) and guar gum (0.25%) were dry blended with sucrose and then were added under high agitation to the tank containing fluid milk and RO water. Second, cocoa powders (1%) were hydrated during 90 min at about 90° C., and then were added to the tank under continuous agitation. Third, milk cream (4.5%) was added to the tank under continuous high agitation. A small amount of additional water was added to adjust the total product amount to 100 kg.

The liquid was pre-heated at 78±5° C., UHT treated for 5 sec at 150° C., cooled to 78±5° C., homogenized at 200/50 bar, cooled to 20° C. and then aseptically filled into PET bottles. The beverage can be aseptically filled in any aseptic containers, e.g. Tetra Paks, jars, jugs or pouches.

Beverage physico-chemical properties were evaluated and sensory characteristics were judged by non-trained panelists. No phase separation including syneresis, gelation, marbling and practically no sedimentation were found during the storage. It was found that the chocolate drink has good appearance, mouth-feel, smooth texture similar to the Full Fat/Full Sugar recipe.

### Example 5

A chocolate beverage was prepared as in Example 4 but using tara gum (0.25%) instead of guar gum in the beverage preparation. Beverage physico-chemical properties were evaluated and sensory characteristics were judged by non-trained panelists. No phase separation including syneresis, gelation, marbling and practically no sedimentation were found during the storage. It was found that the chocolate drink has good appearance, mouth-feel, smooth texture similar to the Full Fat/Full Sugar recipe.

### Example 6

A chocolate beverage was prepared as in Example 4 but using carboxymethylcellulose (0.2%) instead of guar gum in the beverage preparation. Beverage physico-chemical properties were evaluated and sensory characteristics were judged by non-trained panelists. No phase separation including syneresis, gelation, marbling and practically no sedimentation were found during the storage. It was found that the chocolate drink has good appearance, mouth-feel, smooth texture similar to the Full Fat/Full Sugar recipe.

### Example 7

A chocolate beverage was prepared as in Example 4 but using 0.1% of gellan gum and 0.05% of guar gum. Beverage physico-chemical properties were evaluated and sensory characteristics were judged by non-trained panelists. Some sedimentation was found during the storage. It was found that the chocolate drink has much less body and watery mouth-feel compared to the Full Fat/Full Sugar recipe.

### Example 8

A chocolate beverage was prepared as in Example 4 but using 0.05% of gellan gum and 0.25% of guar gum. Beverage physico-chemical properties were evaluated and sensory characteristics were judged by non-trained panelists. No phase separation including syneresis, gelation, marbling and practically no sedimentation were found during the storage. It was found that the chocolate drink has good appearance, mouth-feel, smooth texture similar to the Full Fat/Full Sugar recipe.

### Example 9

A chocolate beverage was prepared as in Example 4 but using 0.025% of gellan gum and 0.25% of guar gum. Beverage physico-chemical properties were evaluated and sensory characteristics were judged by non-trained panelists. Moderate sedimentation was found during the storage. It was found that the chocolate drink has less body/mouth-feel compared to the Full Fat/Full Sugar recipe.

### Example 10

A chocolate beverage was prepared as in Example 4 but using 0.25% of gellan gum and 0.25% of guar gum. Beverage physico-chemical properties were evaluated and sensory characteristics were judged by non-trained panelists. Slimy, “gelly” texture and unacceptable mouth-feel of the chocolate drink were found.

### Example 11

A chocolate beverage was prepared as in Example 4 but using 0.1% of gellan gum and 0.1% of guar gum. Beverage physico-chemical properties were evaluated and sensory characteristics were judged by non-trained panelists. No phase separation as well as good appearance, mouth-feel/texture similar to the Full Fat/Full Sugar recipe were found for the chocolate drink.

### Example 12

A chocolate beverage was prepared as in Example 4 but using 0.2% of gellan gum and 0.05% of guar gum. Beverage physico-chemical properties were evaluated and sensory characteristics were judged by non-trained panelists. No phase separation as well as good appearance, mouth-feel/texture similar to the Full Fat/Full Sugar recipe were found for the chocolate drink.

### Example 13

A chocolate beverage was prepared as in Example 4 but using 0.4% of gellan gum and 0.05% of guar gum. Beverage physico-chemical properties were evaluated and sensory characteristics were judged by non-trained panelists. It was found that the chocolate drink has unacceptable “gelly” texture and unacceptable mouth-feel compared to the Full Fat/Full Sugar recipe.

### Example 14

A chocolate beverage was prepared as in Example 4 but using 0.05% of gellan gum and 0.3% of guar gum. Beverage physico-chemical properties were evaluated and sensory characteristics were judged by non-trained panelists. It was found that the chocolate drink has gummy, “gelly” texture and unacceptable mouth-feel compared to the Full Fat/Full Sugar recipe.

In summary, these examples demonstrate the benefits of the preferred concentrations of the components of the stabilizing system.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A beverage comprising:
water;
a dairy component;
a cocoa component; and
a stabilizing system comprising gellan gum, carrageenan and at least one ingredient selected from the group consisting of carboxymethylcellulose, guar gum and tara gum.

2. The beverage of claim 1, wherein the stabilizing system comprises:
gellan gum in an amount from about 0.05% to 0.35% of the beverage;
carrageenan in an amount from about 0.0025% to about 0.1% of the beverage; and
carboxymethylcellulose in an amount from about 0.05% to 0.2% of the beverage;
the viscosity of the beverage being from about 18 cP to about 70 cP at 4° C.

3. The beverage of claim 1, wherein the stabilizing system comprises:
gellan gum in an amount from about 0.11% to 0.35% of the beverage;
carrageenan in an amount from about 0.0025% to about 0.1% of the beverage; and
guar gum in an amount from about 0.05% to about 0.25% and less than the amount calculated by the equation:
[Guar gum %]=0.575−1.5*[Gellan gum %]

4. The beverage of claim 1, wherein the stabilizing system comprises:
gellan gum in an amount from about 0.05% to about 0.11% of the beverage;
carrageenan in an amount from about 0.0025% to about 0.1% of the beverage; and
guar gum in an amount from about 0.05% to about 0.25% and more than the amount calculated by the equation:
[Guar gum %]=0.4−3*[Gellan gum %]

5. The beverage of claim 1, wherein the stabilizing system comprises:
gellan gum in an amount from about 0.11% to 0.35% of the beverage;
carrageenan in an amount from about 0.0025 to about 0.1% of the beverage; and
tara gum in the range from about 0.05% to about 0.25% and less than the amount calculated by the equation:
[Tara gum %]=0.575−1.5*[Gellan gum %]

6. The beverage of claim 1, wherein the stabilizing system comprises:
gellan gum in an amount from about 0.05% to about 0.11% of the beverage;
carrageenan in an amount from about 0.0025% to about 0.1% of the beverage; and
tara gum in the range from about 0.05% to about 0.25% and more than the amount calculated by the equation:
[Tara gum %]=0.4−3*[Gellan gum %]

7. The beverage of claim 1, wherein the cocoa component is selected from the group consisting of natural cocoa, alkalized cocoa and combinations thereof.

8. The beverage of claim 7, wherein the cocoa component is present in an amount of from about 0.5% to about 1.5% of the beverage.

9. The beverage of claim 1, wherein the dairy component comprises less tham about 3.0% milk fat.

10. The beverage of claim 9, wherein the milk fat is the only fat in the beverage.

11. The beverage of claim 1 comprising less than about 6.0% sugar and less than about 0.1% sugarless sweetener.

12. The beverage of claim 1, wherein the dairy component comprises dairy proteins in an amount of from about 2.0% to about 4.0% of the beverage.

13. The beverage of claim 1, wherein the gellan gum is present in the beverage in an amount of about 0.11% of the beverage, and the carrageenan is present in the beverage in an amount of about 0.01% of the beverage.

14. A ready to drink aseptic beverage comprising:
water;
a dairy component;
a cocoa component; and
a stabilizing system comprising gellan gum, carrageenan and at least one ingredient selected from the group consisting of carboxymethylcellulose, guar gum and tara gum, and the stabilizing system maintains the aseptic chocolate beverage in a homogenous state for at least nine months at 4° C., at least six months at 25° C., at least three months at 30° C. and at least one months at 38° C.

15. A method of producing a ready to drink dairy chocolate beverage comprising the steps of adding a stabilizing system to a dairy component and a cocoa component, the stabilizing system comprising gellan gum, carrageenan and at least one ingredient selected from the group consisting of carboxymethylcellulose, guar gum and tara gum.
